(19) United States
(12) Patent Application Publication
(10) Pub. No.: US 2009/0074978 A1
(43) Pub. Date: Mar. 19, 2009

(54) METHOD OF MAKING CARBAMATE FUNCTIONAL MATERIALS

(75) Inventor: Walter H. OHRBOM, HARTLAND TOWNSHIP, MI (US)

Correspondence Address: Harness, Dickey and Pierce, P.L.C., 5445 Corporate Drive, Troy, MI, 48098, US

(73) Assignee: BASF CORPORATION, SOUTHFIELD, MI (US)

(21) Appl. No.: 11/854,636

(22) Filed: Sep. 13, 2007

(51) Int. Cl. B05D 3/00; C08G 63/78

(52) U.S. Cl. 427/385.5; 528/361

(57) ABSTRACT

A method of preparing a coating composition comprises reacting a first material having a group

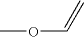

or an ester of a low-boiling alcohol with a compound having a carbamate group and a hydroxyl group, wherein the reaction is catalyzed by an enzyme, to form a carbamate-functional material and then combining the carbamate-functional material with a crosslinker having carbamate-reactive groups in a coating composition.

### FIELD

The present disclosure concerns methods of making polymers and compounds having carbamate groups and to coatings containing such materials.

### BACKGROUND

The statements in this section provide background information in relation to the present disclosure and may or may not constitute prior art.

Clearcoat-basecoat composite coatings are widely used in the coatings art and are notable for desirable gloss, depth of color, distinctness of image and/or special metallic effects. Composite systems are particularly utilized by the automotive industry to achieve advantageous visual effects, especially a high degree of clarity. However, a high degree of clarity in the clearcoat makes it easier to observe defects, among which are defects from degradation by environmental effects on the coating.

The clearcoat layer also provides protection of the substrate and lower coating layers from environmental degradation. Curable coating compositions utilizing carbamate-functional resins have been used in coatings and are described, for example, in U.S. Pat. Nos. 5,693,724, 5,693,723, 5,639,828, 5,512,639, 5,508,379, 5,451,656, 5,356,669, 5,336,566, and 5,532,061, each of which is incorporated herein by reference. These coatings can provide significant improvements in resistance to environmental etch over other coatings using other compositions, such as hydroxy-functional acrylic/melamine coating compositions.

U.S. Pat. Nos. 5,693,724, 5,693,723, 5,639,828, 5,512,639, 5,508,379, 5,451,656, 5,356,669, 5,336,566, 5,532,061 and 6531560 describe incorporating carbamate functionality by ‘trans-carbamating’ hydroxyl-functional acrylic resins with hydroxy carbamate compounds. The reaction step is a time-consuming process, however, and produces side products like methanol that, along with other solvents used for the reaction medium, must be removed somehow. Moreover, undersirable side reactions may take place to some degree. Vinyl polymers prepared from acrylates and methacrylates have been extensively used for topcoats such as automotive clearcoats and basecoats because of the excellent balance of properties they provide in coatings that are tough, durable, and glossy. Derango et al., “The Lipase-Catalyzed Synthesis of Carbamoyloxyethyl Methacrylate,” Biotechnology Letters, Vol. 16, No. 3 (March 1994) pp. 241-46 describes using lipase as a catalyst for transesterification of 2-hydroxyethylcarbamate with vinyl methacrylate to prepare carbamoyloxyethyl methacrylate. Dietsche et al., U.S. Pat. No. 7,164,037 teaches an enzymatic preparation of (meth)acrylic esters containing urethane groups and their use in radiation-curable composition, the reaction producing as a by-product a low boiling point alcohol.

### SUMMARY

A method of preparing coatings containing carbamate-functional materials, which may be polymers, oligomers, or crosslinkable compounds, includes catalyzing addition of a hydroxy compound containing a carbamate group to a polymer, oligomer, or compound comprising a carbon-carbon double bond with lipase. The carbamate functional reaction products are useful in coating compositions. Oligomers are polymers having relatively few monomer units; generally, “oligomer” refers to polymers with ten or fewer monomer units; polymers will be used as inclusive of olligomers. “Compounds” will refer to nonpolymer materials.

In the method, a material (polymer or compound) having a group

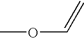

is reacted with a hydroxy functional carbamate material in the presence of lipase to introduce carbamate functionality onto the material. The carbamated material is then included in a coating composition, especially a clearcoat coating composition used to form a cured coating on a substrate.

In another aspect, a material having a structure

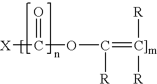

in which n is 0 or 1, m is an integer greater, each R is independently H or an alkyl group of 1 to 4 carbon atoms, and X is an m-valent material (polymer, oligomer, or compound), particularly such a material where n is 1 and each R is H, is reacted with a hydroxy functional carbamate material in the presence of lipase to introduce carbamate functionality onto the material. The carbamated material is then included in a coating composition, especially a clearcoat coating composition used to form a cured coating on a substrate.

In another aspect, a hydroxy compound with carbamate functionality is added to a polymer, oligomer or compound having an ester of a low boiling point alcohol (usually a methyl to propyl ester) via enzymatic transcarbamation.

The term “carbamate group” as used in connection with the present invention refers to a group having a structure:

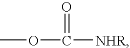

in which R is H or alkyl, preferably R is H or alkyl of from 1 to about 8 carbon atoms, more preferably R is H or alkyl of from 1 to about 4 carbon atoms, and yet more preferably R is H. When R is H, the carbamate group is referred to as a primary carbamate group.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all values and further divided ranges within the entire range.

Further areas of applicability will become apparent from the description provided herein. It should be understood that the description and specific examples are intended for purposes of illustration only and are not intended to limit the scope of the present invention.

### DETAILED DESCRIPTION

Addition of a hydroxy compound containing a carbamate group to a polymer, oligomer, or compound comprising a carbon-carbon double bond is catalyzed by lipase. In another aspect of the invention, transesterification of a hydroxy compound containing a carbamate group to an ester group of a polymer, oligomer, or compound, the alcohol radical of the ester group having one to three carbon atoms, is catalyzed by lipase. Nonlimiting examples of hydroxy compounds containing a carbamate group include hydroxyalkyl carbamate compounds prepared from the ring-opening of cyclic carbonates with ammonia (form primary carbamate groups) or primary or secondary amines (for secondary or tertiary carbamate groups) such as hydroxyethyl carbamate, beta-hydroxypropyl carbamate, and gamma-hydroxy carbamate; the beta-hydroxy carbamate formed from the reaction of carbon dioxide with 2,3-epoxy-1-propanol or the expoxy ester of neodecanoate; and assymetric hydroxy carbamates as covered by Ohrbom et al., U.S. Pat. Nos. 6,977,309 and 6,858,674.

The material comprising a carbon-carbon double bond may be a polymer, such as a vinyl polymer, a polyester, a polyurethane, or a polyether. A vinyl polymer having a pendent ethenoxy group may be prepared by the free radical polymerization of a material containing active double bonds and non-activated double bonds. An example of such a material is vinyl methacrylate. Examples of suitable co-monomers include, without limitation, α,β-ethylenically unsaturated monocarboxylic acids containing 3 to 5 carbon atoms such as acrylic, methacrylic, and crotonic acids and the esters of those acids; α,β-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tert-butyl, 2-ethylhexyl, lauryl, stearyl, cyclohexyl, trimethylcyclohexyl, tetrahydrofurfuryl, stearyl, sulfoethyl, and isobornyl acrylates, methacrylates, and crotonates. Representative examples of other ethylenically unsaturated polymerizable monomers include, without limitation, such compounds as fumaric, maleic, and itaconic anhydrides, monoesters, and diesters with alcohols such as methanol, ethanol, propanol, isopropanol, butanol, isobutanol, and tert-butanol. Representative examples of polymerization vinyl monomers include, without limitation, such compounds as vinyl acetate, vinyl propionate, vinyl ethers such as vinyl ethyl ether, vinyl and vinylidene halides, and vinyl ethyl ketone. Representative examples of aromatic or heterocyclic aliphatic vinyl compounds include, without limitation, such compounds as styrene, α-methyl styrene, vinyl toluene, tert-butyl styrene, and 2-vinyl pyrrolidone. The co-monomers may be used in any desired combination to produce desired vinyl or acrylic polymer properties.

The vinyl polymer may be prepared using conventional techniques, such as by heating the monomers in the presence of a polymerization initiating agent and optionally chain transfer agents. The polymerization is preferably carried out in solution, although it is also possible to polymerize the acrylic polymer in bulk. Suitable polymerization solvents include, without limitation, esters, ketones, ethylene glycol monoalkyl ethers and propylene glycol monoalkyl ethers, alcohols, and aromatic hydrocarbons such as xylene, toluene, and Aromatic 100.

Typical initiators are organic peroxides such as dialkyl peroxides such as di-tert-butyl peroxide, peroxyesters such as tert-butyl peroctoate and tert-butyl peracetate, peroxydicarbonates, diacyl peroxides, hydroperoxides such as tert-butyl hydroperoxide, and peroxyketals; azo compounds such as 2,2′azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol, and dimeric alpha-methyl styrene.

The solvent or solvent mixture may be heated to the reaction temperature and the monomers and initiator(s) and optionally chain transfer agent(s) added at a controlled rate over a period of time, typically from about two to about six hours. The polymerization reaction may usually be carried out at temperatures from about 20° C. to about 200° C. The reaction may conveniently be done at the temperature at which the solvent or solvent mixture refluxes, although with proper control a temperature below the reflux may be maintained. The initiator should be chosen to match the temperature at which the reaction is carried out, so that the half-life of the initiator at that temperature should preferably be no more than about thirty minutes, more preferably no more than about five minutes. Additional solvent may be added concurrently. The mixture may be held at the reaction temperature after the additions are completed for a period of time to complete the polymerization. Optionally, additional initiator may be added to ensure complete conversion of monomers to polymer.

An acrylic polymer having groups

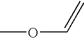

may be prepared by taking advantage of the lower reactivity of the vinyl group relative to acrylate or methacrylate groups in addition polymerization, so that polymerization of vinyl (meth)acrylate with other acrylate or methacrylate monomers can be achieved without reaction of the vinyl group of the vinyl (meth)acrylate.

A polyurethane polymer having an ethenoxy group may also be used. Polyurethane polymers are prepared by reaction of a compounds or macromonomers having two hydroxyl groups, for example compounds such as alkylene glycols and polyalkylene glycols such as ethylene glycol, propylene glycol, diethylene glycol, triethylene glycol, and neopentyl glycol; 1,4-butanediol, 1,6-hexanediol, 1,4-cyclohexane dimethanol, glycerine, trimethylolpropane, trimethylolethane, pentaerythritol, 2,2,4-trimethyl-1,3-pentanediol, hydrogenated bisphenol A, hydroxyalkylated bisphenols, and macromonomers such as polyester diols, with a diisocyanate materials. When the coating composition is a topcoat (including basecoat and clearcoat) composition, the diisocyanate is aliphatic, for example isophorone diisocyanate, hexamethylene diisocyanate or cyclohexamethylene diisocyanate. In a preferred embodiment, the polyurethane is prepared in two stages, with an isocyanate-functional prepolymer prepared in the first stage and capped with a polyhydroxyl compound, such a trimethylolpropane, pentaerythritol, diethanolamine, and so on. Polyester polymers are prepared by reaction of dihydroxy compounds, such as those already mentioned, and dicarboxylic acids. An ethenoxy group is introduced onto the polyurethane by the reaction of a carboxyl, hydroxyl, oxirane, or cyclic anhydride functional vinyl material.

A polyester polymer having a methenoxy group may also be used. Polyester polymers are prepared by reaction of a compounds or macromonomers having two hydroxyl groups, for example those already mentioned, with a compound or macromonomer having two carboxylic groups or an anhydride group. Dicarboxylic acids or anhydrides of dicarboxylic acids are preferred, but higher functional acid and anhydrides can be used when some branching of the polyester is desired. Non-limiting examples of suitable carboxylic acids and anhdyride include those having from about 3 to about 20 carbon atoms. Illustrative examples of suitable compounds include, without limitation, phthalic acid, isophthalic acid, terephthalic acid, hexahydrophthalic acid, tetrahydrophthalic acid, pyromellitic acid, malonic acid, maleic acid, succinic acid, azeleic acid, glutaric acid adipic acid, azelaic acid, 1,4-cyclohexanedicarboxylic acid, dodecane-1,12-dicarboxylic acid, citric acid, trimellitic acid, and anhydrides thereof. An ethenoxy group is introduced onto the polyurethane by copolymerization of mono- or polyhydroxy materials with ethenyl groups such as the ethenyl ester of 3-hydroxypropionic acid, or the ethenyl ester of 3-hydroxy-2-(hydroxymethyl)-2-methylpropanoic acid.

A non-limiting, suitable example of a compound having at least two ethenoxy groups is the diethyenyl ester of 3-hydroxyadipic acid.

The reaction between the hydroxy carbamate compound and the polymer or compound with ethenoxy groups is catalyzed by lipase. Crude lipases AK, PS-30, CES from Pseudomonas sp., lipase AP from Aspergillus niger sp., lipase MAP from Mucor sp., lipase G from Penicillium cyclopium sp., lipase GC from Geotricum candidum sp., lipase FAP from Rhizopus javanicus, are available from Amano International Enzyme Company, Troy, Va. The enzyme is preferably used in aqueous mixture or in an organic solvent or solvent mixture that preserves a small monolayer of water surrounding the enzyme. Aromatic hydrocarbon solvents such as toluene, xylene, and mixtures of aromatic hydrocarbons with range of fractional distillation of 90 to 220° C. obtained by fractionally distilling coal tar-based light oil and petroleum-based light oil can be used, such as Solvesso 100 and Aromatic 100 (from Exxon.Mobil Corp.), which have boiling point solvents with range of fractional distillation of 160 to 180° C., and Solvesso 150 and Aromatic 150 (from Exxon.Mobil Corp.), which have boiling point solvents with range of fractional distillation of 180 to 220° C.

The reaction mixture containing the lipase, the hydroxy compound containing a carbamate group and the polymer or compound comprising a carbon-carbon double bond may be heated to a reaction temperature of from 30° C. up to about 120° C., preferably from about 40° C. up to about 60° C. The reaction temperature depends at least in part on the thermal stability of the hydroxy carbamate being reacted; beta hydroxy carbamates can undergo unwanted de-ammination to reforem cyclic carbonates, a side-reaction that should be avoided. In using compounds susceptible to this side-reaction, it may be helpful to keep the reaction temperature under 60° C. When the carbamate and hydroxyl groups are separated by three or more carbon atoms, the reactant compound is usually stable enough to use reaction temperatures up to about 120° C. The reaction mixture is held at the reaction temperature until the reaction is complete, typically from about four to about forty hours. The by-product may be left in the reaction product or drawn off by distillation or vacuum distillation.

Alternatively, a hydroxy compound with carbamate functionality is added to a polymer, oligomer or compound having an ester of a low boiling point alcohol (usually a methyl to propyl ester) via enzymatic transcarbamation using techniques to make carbamate functional (meth)acrytlic monomers as taught in U.S. Pat. No. 7,164,037. In this approach, the material to which the hydroxy carbamate compound is adducted contains one or more esters of low boiling point alcohol, usually a methyl, ethyl or propyl ester. The material containing the ester group(s) is heated in the presence of a hydroxy carbamate as described above. Enzymes which can be used to catalyze the adduction reaction are selected for example from hydrolases, esterases (E.C. 3.1.-.-), lipases (E.C. 3.1.1.3), glycosylases (E.C. 3.2.-.-) and proteases (E.C. 3.4.-.-) in free form or in a form in which they are chemically or physically immobilized on a carrier, preferably lipases, esterases or proteases. Particular preference is given to Novozyme 435 (lipase from Candida antarctica B) or lipase from Aspergillus sp., Aspergillus niger sp., Mucor sp., Penicillium cyclopium sp., Geotricum candidum sp., Rhizopus javanicus, Burkholderia sp., Candida sp., Pseudomonas sp., or porcine pancreas, very particular preference to lipase from Candida antarctica B or from Burkholderia sp.

The enzyme content of the reaction medium lies generally in the range from about 0.1 to 10% by weight, based on the sum of the reactants employed. The reaction time depends among other things on the temperature, on the amounts and activity of the enzyme catalyst used, and on the required conversion, and also on the alcohol containing the carbamate groups. The reaction time is preferably adapted so that the conversion of all hydroxyl groups originally present in the alcohol with carbamate groups is at least 70%, preferably at least 80%, more preferably at least 90% and very preferably at least 95%. For this a time of from 1 to 48 hours and preferably from 1 to 12 hours is generally sufficient. Mild vacuum may be applied to remove the generated low boiling point alcohol side product. The reaction temperature is usually between 30° C. to 120° C., and is selected based on the stability of the hydroxy carbamate as described above.

The material having esters of low boiling point alcohols may be acrylic polymers of methyl, ethyl and/or propyl (meth)acrylate where the other co-monomers may be taken from the comonomer list provided above. Methanol, ethanol and/or propanol may be used to incorporate the low boiling point esters in polyesters or polyethers. Carboxyl-functional methyl to propyl esters may be used to react onto epoxide-functional polymers, oligomers and materials. Hydroxy-functional methyl to propyl esters may be used to incorporate low boiling point esters into urethane polymers, oligomers and materials.

The polymers or compounds prepared by these methods may incorporated into coating compositions. In preferred embodiments, the coating compositions are thermosetting. Such coating compositions may be used to coating automotive and industrial substrates. The industrial and automotive coatings may be primers or topcoats, including one-layer topcoats and basecoat/clearcoat composite coatings.

The thermosetting coating composition preferably further includes a curing agent or crosslinker that is reactive with the carbamate functionality of the polymer or compound. The curing agent has, on average, at least about two reactive functional groups.

Useful curing agents include materials having active methylol or methylalkoxy groups, such as aminoplast crosslinking agents or phenol/formaldehyde adducts. Examples of preferred curing agent compounds include, without limitation, melamine formaldehyde resin (including monomeric or polymeric melamine resin and partially or fully alkylated melamine resin), and urea resins (e.g., methylol ureas such as urea formaldehyde resin, alkoxy ureas such as butylated urea formaldehyde resin). The curing agent may be combinations of these. Aminoplast resins such as melamine formaldehyde resins or urea formaldehyde resins are especially preferred. Combinations of tris(alkoxy carbonylamino) triazine with a melamine formaldehyde resin and/or a blocked isocyanate curing agent are likewise suitable and desirable.

The coating composition may be prepared using the solvents in which the reaction with hydroxy carbamate compound is carried out, or the reaction solvents may be removed by distillation and replace with other solvents. In general, the solvent used in the coating composition can be any organic solvent and/or water. In one preferred embodiment, the solvent includes a polar organic solvent. More preferably, the solvent is selected from polar aliphatic solvents or polar aromatic solvents. Still more preferably, the solvent is a ketone, ester, acetate, aprotic amide, aprotic sulfoxide, aprotic amine, or a combination of any of these. Examples of useful solvents include, without limitation, methyl ethyl ketone, methyl isobutyl ketone, m-amyl acetate, ethylene glycol butyl ether-acetate, propylene glycol monomethyl ether acetate, xylene, N-methylpyrrolidone, blends of aromatic hydrocarbons, and mixtures of these. In another preferred embodiment, the solvent is water or a mixture of water with small amounts of co-solvents.

Coating compositions can be coated on the article by any of a number of techniques well-known in the art. These include, for example, spray coating, dip coating, roll coating, curtain coating, and the like. For automotive body panels, spray coating is preferred.

The coating compositions of the invention include topcoat compositions, including one-layer pigmented topcoat compositions as well as clearcoat and basecoat two-layer topcoat compositions. When the resins of the invention are utilized in aqueous compositions, they may include monomers with groups that can be salted, i.e., acid groups or amine groups.

Additional agents, for example surfactants, fillers, stabilizers, wetting agents, dispersing agents, adhesion promoters, UV absorbers, hindered amine light stabilizers, etc. may be incorporated into the coating composition. While such additives are well-known in the prior art, the amount used must be controlled to avoid adversely affecting the coating characteristics.

When the coating composition of the invention is used as a high-gloss pigmented paint coating, the pigment may be any organic or inorganic compounds or colored materials, fillers, metallic or other inorganic flake materials such as mica or aluminum flake, and other materials of kind that the art normally includes in such coatings. Pigments and other insoluble particulate compounds such as fillers are usually used in the composition in an amount of 1% to 100%, based on the total solid weight of binder components (i.e., a pigment-to-binder ratio of 0.1 to 1). Preferably, the coating composition of the invention is a clearcoat coating composition, which has no pigments.

The coating compositions described herein are preferably subjected to conditions so as to cure the coating layers. Although various methods of curing may be used, heat-curing is preferred. Generally, heat curing is effected by exposing the coated article to elevated temperatures provided primarily by radiative heat sources. Curing temperatures will vary depending on the particular blocking groups used in the cross-linking agents, however they generally range between 90° C. and 180° C. The first compounds according to the present invention are preferably reactive even at relatively low cure temperatures. Thus, in a preferred embodiment, the cure temperature is preferably between 115° C. and 150° C., and more preferably at temperatures between 115° C. and 140° C. for a blocked acid catalyzed system. For an unblocked acid catalyzed system, the cure temperature is preferably between 80° C. and 100 C. The curing time will vary depending on the particular components used, and physical parameters such as the thickness of the layers, however, typical curing times range from 15 to 60 minutes, and preferably 15-25 minutes for blocked acid catalyzed systems and 10-20 minutes for unblocked acid catalyzed systems.

The invention is further described in the following examples. The examples are merely illustrative and does not in any way limit the scope of the invention as described and claimed. All parts are parts by weight unless otherwise noted.

### EXAMPLES

### Example One

### Part One

A solution of 20 parts of xylene is heated to 140° C. under an inert atmosphere. Then a mixture of 26 parts of vinyl methacrylate, 5 parts of styrene, 25 parts of butyl acrylate, 9 parts of cyclohexane methacrylate, 5.2 parts of t-butyl peroxy-2-ethylhexanoate and 7 parts of amyl acetate are added at a constant rate over four hours. Then 2.8 parts of xylene are added. The reaction mixture is held at 140° C. for two hours. The final resin will have a vinyl equivalent weight of 430 g/equ (solution) and a NV of about 67.6%.

### Part Two

To 100 parts of the resin from example one part one is added 50 parts of hydroxy ethyl carbamate and 1 part of PS-30 Pseudomonas. The reaction mixture is then heated under an inert atmosphere to 50° C. and held until the reaction is complete (as determined by GC analysis of loss of hydroxy ethyl carbamate). Then the solvent and excess hydroxy ethyl carbamate are removed under mild vacuum distillation where the distillation temperature is kept below 120° C. Then 30 parts of amyl acetate is added. The final resin will have a NV content of about 62% and a carbamate equivalent weight on solution of 524 g/equ.

### Example 2

### Part One

A solution of 120 parts of xylene, 158 parts of the homopolymer of isophorone diisocyanate, and 0.2 parts of dibutyl tin dilaurate is heated under an inert atmosphere to 60° C. Then 74 parts of the ethenyl ester of 3-hydroxypropanoic acid is slowly added. The reaction mixture is allowed to exotherm to 80° C. during the addition. The reaction is held at 80° C. and followed by infrared spectroscopy until the reaction is complete. Then 5 parts of butanol is added. The resin will have a NV content of about 65% and a vinyl equivalent weight of 562 g/equ on solution.

### Part Two

To 100 parts of the resin from part one of this example is added 40 parts of hydroxy ethyl carbamate and 1 part of PS-30 Pseudomonas. The reaction mixture is then heated under an inert atmosphere to 50° C. and held until the reaction is complete (as determined by GC analysis of loss of hydroxy ethyl carbamate). Then the solvent and excess hydroxy ethyl carbamate is removed under mild vacuum distillation where the distillation temperature is kept below 120° C. The final solid material has a carbamate equivalent weight of 470 g/equ. It can be used as a powder, or reduced in solvent (such as amyl acetate).

### Example 3

### Part One

A solution of 120 parts of xylene and 158 parts of the homopolymer of Isophorone diisocyanate and 0.2 parts of dibutyl tin dilaurate are heated under an inert atmosphere to 60° C. Then 67 parts of methyl-3-hydroxypropanoate is slowly added. The rate of addition is monitored in order to keep the reaction temperature below 70° C. Once all of the 2-hydroxyethyl acrylate has been added, the reaction mixture is kept at 70° C. until the reaction is complete (as determined by infrared spectroscopy). Then 5 parts of butanol is added. The resin will have a NV of 64% and a methyl ester equivalent weight of 543 g/equ on solution.

### Part Two

100 parts of the resin from example three part one, 44 parts of hydroxypropyl carbamate and 2 parts of Novozym 435 (company Novozymes) is heated to 70° C. under an inert atmosphere in a reactor equipped with a trap. The reaction is kept at 70° C. and monitored by removal of water and disappearance of hydroxypropyl carbamate. Once the reaction is complete, the excess hydroxypropyl carbamate and solvent is removed under mild vacuum distillation where the distillation temperature is kept below 120° C. The final solid material has a carbamate equivalent weight of 466 g/equ. It can be used as a powder, or reduced in solvent (such as amyl acetate).

The invention has been described in detail with reference to preferred embodiments thereof. It should be understood, however, that variations and modifications can be made within the spirit and scope of the invention and of the following claims.

1. A method of preparing a coating composition, comprising:
reacting a first material having a group 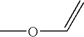
with a compound having a carbamate group and a hydroxyl group in the presence of lipase, to form a carbamate-functional material; and
combining the carbamate-functional material with a crosslinker having carbamate-reactive groups in a coating composition.

2. A method according to claim 1, wherein the compound having a carbamate group and a hydroxyl group is a hydroxyalkyl carbamate.

3. A method according to claim 1, wherein the first material is a polymer.

4. A method according to claim 3, wherein the polymer is selected from vinyl polymers, acrylic polymers, polyesters, and polyurethanes.

5. A method according to claim 3, wherein the polymer is an acrylic copolymer of vinyl acrylate or vinyl methacrylate.

6. A method according to claim 1, wherein the first material has a plurality of groups

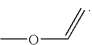

7. A method according to claim 1, wherein the first material is a compound.

8. A method according to claim 7, wherein the compound is a reaction product of a polyisocyanate and an ethenyl ester of a hydroxyalkanoic acid.

9. A method according to claim 1, wherein the crosslinker comprises an aminoplast crosslinking agent.

10. A method according to claim 1, wherein the crosslinker comprises a melamine formaldehyde resin.

11. A method according to claim 1, wherein the group 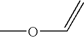
is attached to a carbonyl group.

12. A method of coating a substrate, comprising applying to the substrate a coating composition according to claim 1 and curing the applied coating composition, wherein the curing comprises reacting together the carbamate-functional material and the crosslinker.

13. A method according to claim 12, wherein the coating composition is a clearcoat coating composition.

14. A method of preparing a coating composition, comprising:
reacting a first material having a structure 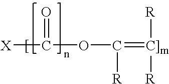
wherein X is a polymer or compound, n is 0 or 1, m is an integer 2 or greater, and each P is independently hydrogen or an alkyl group with 1 to 4 carbon atoms with a compound having a carbamate group and a hydroxyl group in the presence of lipase, to form a carbamate-functional material; and
combining the carbamate-functional material with a crosslinker having carbamate-reactive groups in a coating composition.

15. A method according to claim 14, wherein each R is hydrogen and n is 1.

16. A method of preparing a coating composition, comprising:
reacting a first material having a plurality of ester groups of low-boiling alcohol with a compound having a carbamate group and a hydroxyl group wherein the reaction is catalyzed by an enzyme, to form a carbamate-functional material; and
combining the carbamate-functional material with a crosslinker having carbamate-reactive groups in a coating composition.

17. A method according to claim 16, wherein the compound having a carbamate group and a hydroxyl group is a hydroxyalkyl carbamate.

18. A method according to claim 16, wherein the first material is a polymer.

19. A method according to claim 18, wherein the polymer is selected from vinyl polymers, acrylic polymers, polyesters, and polyurethanes.

20. A method according to claim 18, wherein the polymer is an acrylic copolymer of an acrylate or methacrylate ester of methanol, ethanol, propanol, or isopropanol.

21. A method according to claim 16, wherein the crosslinker comprises an aminoplast crosslinking agent.

22. A method of coating a substrate, comprising applying to the substrate a coating composition according to claim 16 and curing the applied coating composition, wherein the curing comprises reacting together the carbamate-functional material and the crosslinker.

23. A method according to claim 22, wherein the coating composition is a clearcoat coating composition.
